(19) United States
(12) Patent Application Publication
(10) Pub. No.: US 2017/0097560 A1
(43) Pub. Date: Apr. 6, 2017

(54) LIGHT SOURCE DEVICE AND PROJECTOR

(71) Applicant: NEC Display Solutions, Ltd., Tokyo (JP)

(72) Inventors: Masateru MATSUBARA, Tokyo (JP); Osamu WAKABAYASHI, Tokyo (JP)

(21) Appl. No.: 15/125,945

(22) PCT Filed: Mar. 31, 2014
(86) PCT No.: PCT/JP2014/059490

§ 371 Date: Sep. 13, 2016

(51) Int. Cl. G03B 21/20; H04N 9/31; G02B 27/14; G02B 26/00; G02B 27/28; G02B 5/30

(52) U.S. Cl. CPC G03B 21/204; G02B 27/283; G02B 5/3083; G03B 21/2073; G03B 21/2066; G02B 27/141; G02B 26/008; H04N 9/3114

(57) ABSTRACT

A light source device includes a light source, a phosphor unit that includes a phosphor region and a reflection region and that is movable so that blue light from the light source is sequentially radiated to the phosphor region and the reflection region, and a dichroic mirror that guides the first linearly polarized light of the blue light from the light source to the phosphor unit and on which fluorescent light from the phosphor region and the blue light from the reflection region are made incident. A ¼ wavelength plate is provided on an optical path between the dichroic mirror and the phosphor unit, and a polarized light separating element is provided on an optical path between the dichroic mirror and the light source. The dichroic mirror is disposed so that the incident angle of the central beam of the blue light from the reflection region is larger than 45°.

### TECHNICAL FIELD

The present invention relates to a light source device that includes a phosphor, and a projector using the same.

### BACKGROUND ART

Patent Literature 1 describes the light source device of a projector that uses a phosphor as a light source. FIG. 1 illustrates the configuration of the light source device.

Referring to FIG. 1, excitation light source 116 includes a plurality of blue laser diodes (LD). Blue excitation light output from excitation light source 116 is converted into a parallel light flux by collimator lens array 106, and then enters dichroic mirror 115. Excitation light source 116 is disposed so that output light can enter dichroic mirror 115 as S-polarized light. Dichroic mirror 115 is disposed so that the incident angle of the blue excitation light can be 45°.

FIG. 2 illustrates the spectral transmission characteristics of dichroic mirror 115. A vertical axis indicates a transmittance, and a horizontal axis indicates a wavelength (nm). A solid line indicates spectral transmission characteristics with respect to S-polarized light, and a broken line indicates spectral transmission characteristics with respect to P-polarized light. The cutoff wavelength of the S-polarized light is 456 nm, and the cutoff wavelength of the P-polarized light is 434 nm. The cutoff wavelength is a wavelength having a transmittance of 50%.

Dichroic mirror 115 has the characteristics of transmitting light of 456 nm or more and reflecting light less than 456 nm for the S-polarized light, and has the characteristics of transmitting light of 434 nm or more and reflecting light less than 434 nmnm for the P-polarized light. The wavelength of the blue excitation light is, for example, 445 nm. The blue excitation light (S-polarized light) from excitation light source 116 is reflected by dichroic mirror 115.

The blue excitation light (S-polarized light) reflected by dichroic mirror 115 passes through ¼ wavelength plate 108 to be converted into circular polarized light. The blue excitation light (circular polarized light) that passed through ¼ wavelength plate 108 is converged on phosphor layer 103 by condensing lens 109.

Phosphor layer 103 is formed on a substrate on which dichroic coating is formed. The substrate is divided into first to third segments in a circumferential direction, and phosphor layer 103 includes a red phosphor region formed in the first segment, and a green phosphor region formed in the second segment. The third segment has been subjected to reflection coating. The first to third segments are sequentially irradiated with blue excitation light (circular polarized light) by rotating the substrate.

In the first segment, a phosphor excited by blue excitation light emits red fluorescent light. In the second segment, the phosphor excited by blue excitation light emits green fluorescent light. In the third segment, blue excitation light (circular polarized light) is reflected on a reflection coat surface.

The red fluorescent light from the first segment, the green fluorescent light from the second segment, and the blue light (circular polarized light) reflected on the reflection coat surface of the third segment sequentially pass through condensing lens 109 and ¼ wavelength plate 108. Here, the blue light (circular polarized light) from the third segment is converted into P-polarized light after its passage through ¼ wavelength plate 108. The red fluorescent light, the green fluorescent light, and the blue light (P-polarized light) respectively pass through dichroic mirror 115. The red fluorescent light, the green fluorescent light, and the blue light (P-polarized light) that passed through dichroic mirror 115 are output light of the light source device.

### CITATION LIST

### Patent Literature

Patent Literature 1: JP2012-108486A

### DISCLOSER OF INVENTION

There is a variation in the light emission wavelengths of the LDs due to individual difference. In addition, since the light emission wavelengths of the LDs also change depending on the temperature, variation in the LD light emission wavelengths is greater when this temperature dependence is taken into consideration. Thus, in the light source device described in Patent Literature 1, depending on the LD that is used as an excitation light source, it may be difficult to polarize and separate the excitation light (S-polarized light) or the blue light (P-polarized light) from the third segment through dichroic mirror 115, thus causing a reduction in light output intensity of the light source device. Hereinafter, this problem will specifically be described.

In general, the variability range in the light emission wavelengths of the LDs that is caused by individual differences is about 15 nm in peak wavelength of a light emission spectrum, and about 30 nm in the half value range of the light emission spectrum. Here, the range of the variation in the half value range of the light emission spectrum indicates, when half-value widths are represented by wavelengths X1 and X2 (>X1), the difference between wavelength X2 of the half-value width of the light emission spectrum of a LD having a longest peak wavelength and wavelength X1 of the half-value width of the light emission spectrum of a LD having a shortest peak wavelength. For example, the variability range in the light emission wavelengths of the LDs designed so that the peak wavelength of a light emission spectrum can be 445 nm is about 430 nm to 460 nm in the half value range of the light emission spectrum.

On the other hand, according to the spectral transmission characteristics of dichroic mirror 115 illustrated in FIG. 2, in a wavelength region from 434 nm that is the cutoff wavelength of the P-polarized light to 456 nm that is the cutoff wavelength of the S-polarized light, the S-polarized light and the P-polarized light can be separated. A wavelength region in which such polarized light separation is allowed is included in the aforementioned 430 nm to 460 nm range of the variation in the light emission wavelengths of the LDs. Accordingly, depending on the LD that is used as the excitation light source, the wavelength X1 or X2 of the half value range of the light emission spectrum may be equal to or less than 434 nm that is the cutoff wavelength of the P-polarized light or equal to or more than 456 nm that is the cutoff wavelength of the S-polarized light.

For example, when a LD in which the wavelength X1 or X2 of a light emission spectrum exceeds 456 nm is used, excitation light from the LD is transmitted through dichroic mirror 115. In this case, the first to third segments cannot be irradiated with the excitation light.

For example, when a LD in which the wavelength X1 or X2 of a light emission spectrum is less than 434 nm is used, the first to third segments can be irradiated with excitation light. However, the blue light (P-polarized light) from the third segment cannot be used as the output light of the light source device since it is reflected by dichroic mirror 115.

It is an object of the present invention to provide a light source device capable of reducing the influence of the variation in the light emission wavelengths of the LDs, and a projector that uses the same.

In order to achieve the object, according to an aspect of the present invention, there is provided a light source device that includes: a light source that emits blue light having a peak wavelength in a blue wavelength region; a polarized light separating element that is provided to reflect or transmit first linearly polarized light, the polarized light separating element reflecting or transmitting first linearly polarized light of the blue light; a dichroic mirror that is provided to reflect or transmit the first linearly polarized light, the dichroic mirror reflecting or transmitting reflected light or transmitted light from the polarized light separating element; a phosphor unit that includes a phosphor region in which a phosphor is provided and a reflection region in which incident light is reflected, the phosphor unit being movable so that reflected light or transmitted light from the dichroic mirror is sequentially radiated to the phosphor region and the reflection region; and a ¼ wavelength plate that is provided on an optical path between the dichroic mirror and the phosphor unit. The dichroic mirror is disposed so that an incident angle of a central beam of the blue light that is reflected in the reflection region is larger than 45°.

According to another aspect of the present invention, there is provided a projector that includes: the aforementioned light source device; a display element that spatially modulates light output from the light source device to form an image; and a projection optical system that magnifies and projects the image formed by the display element.

### BRIEF DESCRIPTION OF DRAWINGS

FIG. 1 is a schematic diagram illustrating the configuration of a light source device described in Patent Literature 1.

FIG. 2 is a characteristic diagram illustrating the spectral transmission characteristics of the dichroic mirror of the light source device illustrated in FIG. 1.

FIG. 3 is a schematic diagram illustrating the configuration of a light source device according to the first exemplary embodiment of the present invention.

FIG. 4 is a schematic diagram illustrating an example of a phosphor wheel used in the light source device illustrated in FIG. 3.

FIG. 5 is a schematic diagram illustrating an example of a color wheel used in the light source device illustrated in FIG. 3.

FIG. 6 is a characteristic diagram illustrating the spectral transmission characteristics of the dichroic mirror of the light source device illustrated in FIG. 3.

FIG. 7 is a characteristic diagram illustrating the spectral transmission characteristics of a dichroic mirror according to a comparative example.

FIG. 8 is a schematic diagram illustrating an example of a projector including the light source device of the present invention.

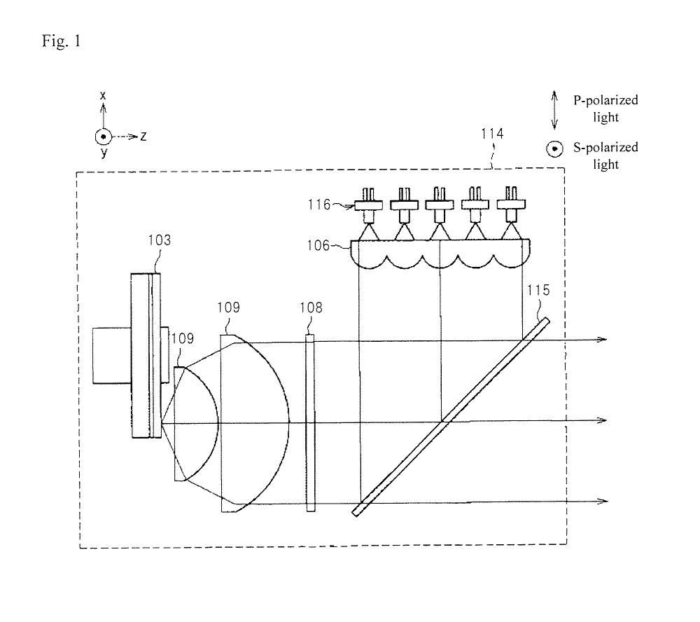

### REFERENCE SIGNS LIST

1a Light source
1b Collimator lens
1c to 1e, 1j, 1k, 1m Lens
1f Polarized light separating element
1g Diffusion plate
1h Dichroic mirror
1i ¼ wavelength plate
1l Phosphor unit
1n Color filter unit

### DESCRIPTION OF EMBODIMENT

Next, the exemplary embodiments of the present invention will be described with reference to the drawings.

### First Exemplary Embodiment

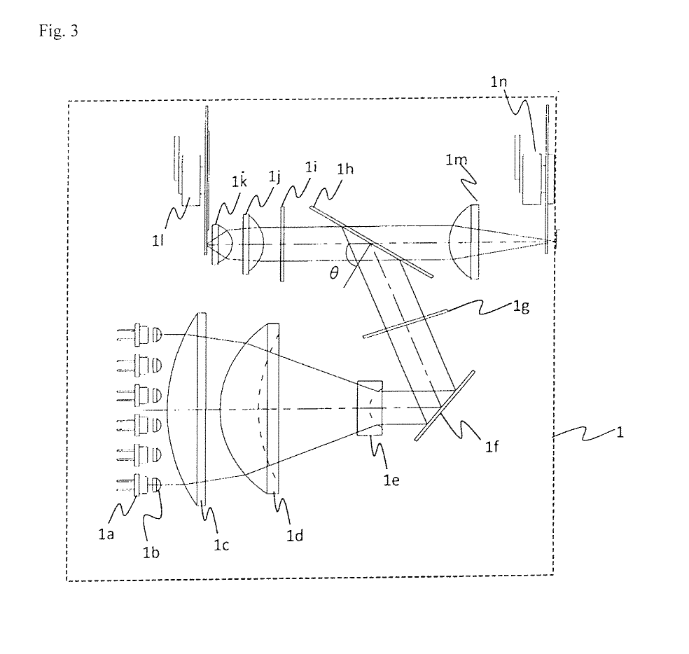

FIG. 3 illustrates the configuration of a light source device according to the first exemplary embodiment of the present invention.

Referring to FIG. 3, light source device 1 includes light source 1a, collimator lens 1b, lenses 1c to 1e, 1j, 1k, and 1m, polarized light separating element 1f, diffusion plate 1g, dichroic mirror 1h, ¼ wavelength plate 1i, phosphor unit 1l, and color filter unit 1n.

Light source 1a includes a blue laser diode (LD) for outputting blue light having a peak wavelength in a blue wavelength region. For example, light source 1a includes blue LDs arranged in the matrix of 6×4. However, the number of blue LDs is not limited to 24. The number of blue LDs may be increased/decreased as needed.

Collimator lens 1b is provided for each blue LD, and converts the blue light output from the blue LD into a parallel light flux.

Lenses 1c to 1e convert each blue light (incident light flux) that is made incident from light source 1a via collimator lens 1b into a parallel light flux in which a light flux diameter is reduced. By setting the diameter of the output light flux to be smaller than that of the incident light flux, the sizes of members arranged after lenses 1c to 1e can be reduced. Here, three lenses 1c to 1e are used. However, the number of lenses is not limited to three. The number of lenses may be increased/decreased as needed.

The blue light emitted from lenses 1c to 1e enters dichroic mirror 1h via polarized light separating element 1f. Diffusion plate 1g is disposed on an optical path between polarized light separating element 1f and dichroic mirror 1h. Diffusion plate 1g diffuses the blue light from polarized light separating element 1f. A diffusion angle is, for example, about 3°. Here, the diffusion angle is an angle formed between a light beam (central beam) that passes through the center of a light flux and a light beam that passes through the outermost side of the light flux.

Polarized light separating element 1f has the characteristics of separating S-polarized light and P-polarized light. Here, polarized light separating element 1f has the characteristics of reflecting the S-polarized light and transmitting the P-polarized light. Light source 1a is disposed so that its output light (blue light) can enter separating element 1f as S-polarized light. A polarization plate or a dichroic mirror can be used for polarized light separating element 1f.

The blue light (S-polarized light) reflected by polarized light separating element 1f enters dichroic mirror 1h. Dichroic mirror 1h has, with respect to light that is made incident as the S-polarized light, the characteristics in which light whose wavelength is equal to or longer than a first wavelength that is longer than that (wavelength of blue light) of light source 1a is transmitted and in which light whose wavelength is shorter than the first wavelength is reflected. In addition, dichroic mirror 1h has, with respect to light that is made incident as the P-polarized light, the characteristics in which light whose wavelength is equal to or longer than a second wavelength that is shorter than that (wavelength of blue light) of light source 1a is transmitted and in which light whose wavelength is shorter than the second wavelength is reflected. Dichroic mirror 1h having such characteristics can be realized by a dielectric multilayer film.

Dichroic mirror 1h guides the blue light (S-polarized light) from polarized light separating element 1f to phosphor unit 1l. ¼ wavelength plate 1i and lenses 1j and 1k are arranged on an optical path between dichroic mirror 1h and phosphor unit 1l.

Phosphor unit 1l includes a phosphor wheel in which a phosphor region having a phosphor excited by excitation light to emit fluorescent light and a reflection region are sequentially arranged in a circumferential direction, and a driving unit (motor) for rotating the phosphor wheel.

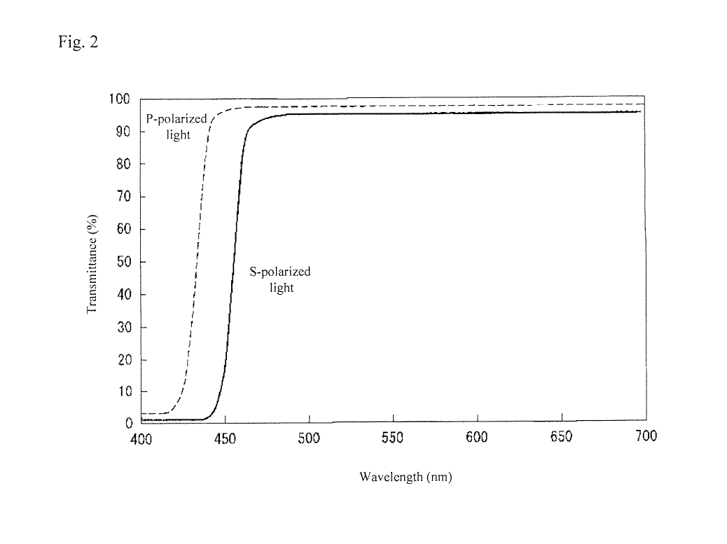

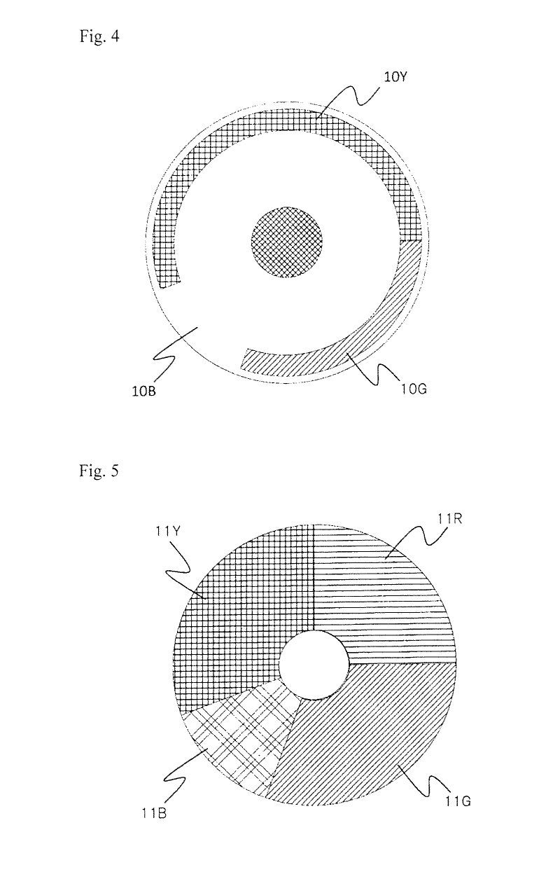

FIG. 4 illustrates an example of the phosphor wheel. Referring to FIG. 2, the phosphor wheel has yellow phosphor region 10Y, green phosphor region 10G, and reflection region 10B. Yellow phosphor region 10Y, green phosphor region 10G, and reflection region 10B are formed so as to be arrayed in the circumferential direction.

Reflection region 10B reflects the blue light from light source 1a. Yellow phosphor region 10Y includes a phosphor that is excited by the excitation light to emit yellow fluorescent light. Green phosphor region 10G includes a phosphor that is excited by the excitation light to emit green fluorescent light. The yellow phosphor and the green phosphor can both be excited by the blue light from light source 1a. Note that the yellow fluorescent light includes the light of a wavelength range from green to red.

The area ratio of each of yellow phosphor region 10Y, green phosphor region 10G, and reflection region 10B in the circumferential direction (division ratio in circumferential direction) is appropriately set according to the balance of the light intensity of each of yellow light, red light, green light, and the blue light included in the output light from light source device 1.

The blue light (S-polarized light) from dichroic mirror 1h passes through ¼ wavelength plate 1i to be converted into circular polarized light. Lenses 1j and 1k converge the blue light (circular polarized light) that passed through ¼ wavelength plate 1i on the phosphor wheel of phosphor unit 1l.

When the phosphor wheel is rotated, the blue light (circular polarized light) from lens 1k is sequentially radiated to yellow phosphor region 10Y, green phosphor region 10G, and reflection region 10B. In yellow phosphor region 10Y, the yellow phosphor excited by the blue light emits yellow fluorescent light. In green phosphor region 10G, the green phosphor excited by the blue light emits green fluorescent light. In reflection region 10B, the blue light from lens 1k is reflected toward lens 1k.

The yellow fluorescent light (unpolarized light) from yellow phosphor region 10Y, the green fluorescent light (unpolarized light) from green phosphor region 10G, and the blue light (circular polarized light) from reflection region 10B respectively pass through lens 1k, lens 1j, and ¼ wavelength plate 1i sequentially to enter dichroic mirror 1h. Here, the blue light (circular polarized light) from reflection region 10B passes through ¼ wavelength plate 1i to be converted into P-polarized light. This blue light (P-polarized light) enters dichroic mirror 1h.

The yellow fluorescent light (unpolarized light), the green fluorescent light (unpolarized light), and the blue light (P-polarized light) that passed through ¼ wavelength plate 1i pass through dichroic mirror 1h. The yellow fluorescent light, the green fluorescent light, and the blue light that passed through dichroic mirror 1h are converged by lens 1m.

Color filter unit 1n includes a color wheel. This color wheel is disposed closer to lens 1m side than the focal position of lens 1m.

FIG. 5 illustrates an example of the color wheel. Referring to FIG. 5, the color wheel has yellow transmission filter 11Y, red transmission filter 11R, green transmission filter 11G, and diffusion plate 11B. Yellow transmission filter 11Y, red transmission filter 11R, green transmission filter 11G, and diffusion plate 11B are formed so as to be arrayed in the circumferential direction.

The regions of yellow transmission filter 11Y and red transmission filter 11R correspond to yellow phosphor region 10Y of the phosphor wheel illustrated in FIG. 4, and green transmission filter 11G and diffusion plate 11B respectively correspond to green phosphor region 10G and reflection region 10B of the phosphor wheel illustrated in FIG. 4. The area ratios of yellow transmission filter 11Y, red transmission filter 11R, green transmission filter 11G, and diffusion plate 11B in the circumferential direction are similar to those of the respective corresponding regions of the phosphor wheel illustrated in FIG. 4.

The area ratios of yellow transmission filter 11Y and red transmission filter 11R in the circumferential direction are appropriately set according to the light intensity balance among the yellow light, the red light, the green light, and the blue light included in the output light from light source device 1.

Color filter unit 1n and phosphor unit 1l are configured to rotate in synchronization with each other. The yellow fluorescent light from yellow phosphor region 110Y includes the light of a yellow component and the light of a red component, the light of the yellow component is transmitted through yellow transmission filter 11Y, and the light of the red component is transmitted through red transmission filter 11R.

The green fluorescent light from green phosphor region 10G is transmitted through green transmission filter 11G. The blue light from reflection region 10B passes through diffusion plate 11B. The diffusion light of the blue light is emitted from diffusion plate 11B. A diffusion angle, which is, for example, about 10°, can be appropriately changed as needed.

The yellow light, the red light, the green light, and the blue light that passed through color filter unit 1n are light output from light source device 1.

According to the embodiment, the incident angle dependence of dichroic mirror 1h is utilized and dichroic mirror 1h is disposed so that incident angle θ of the central beam of the blue light from reflection region 10B is greater than 45°. As a result, a wavelength region in which the S-polarized light and the P-polarized light can be separated is widened. For example, dichroic mirror 1h is disposed so that incident angle θ can be 55°. Thus, the influence of a variation in the light emission wavelengths of LDs that id caused by individual difference or temperature dependence is reduced. Note that the incident angle is an angle formed between an incident light beam and a normal set at an incident point.

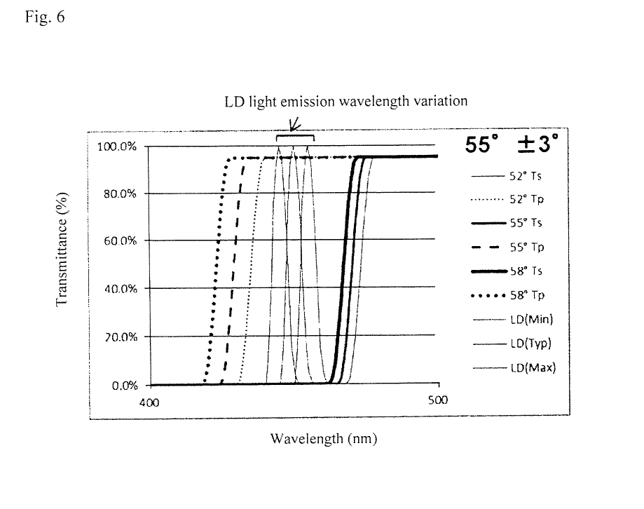

FIG. 6 illustrates the spectral transmission characteristics of dichroic mirror 1h when incident angle θ of the central beam of the blue light from reflection region 10B is 55°. In FIG. 6, a vertical axis indicates a transmittance, and a horizontal axis indicates a wavelength (nm). A broken line indicates characteristics for the P-polarized light, and a solid line indicates characteristics for the S-polarized light.

The blue light from reflection region 10B is diffusion light, whose diffusion angle is 3°. Accordingly, when incident angle θ of the central beam is 55°, the incident angle range of the blue diffusion light made incident on dichroic mirror 1h is 52° to 58°. In FIG. 6, characteristics for the incident angles of 52°, 55°, and 58° are respectively illustrated.

A cutoff wavelength is defined as a wavelength in which a transmittance is 50%. In the characteristics of the incident angle of 55°, a cutoff wavelength for the P-polarized light is 429 nm, and a cutoff wavelength for the S-polarized light is 470 nm. In this case, dichroic mirror 1h generally transmits the P-polarized light whose wavelength is equal to or greater than 429 nm, while generally reflecting the P-polarized light whose wavelength is shorter than 429 nm. In addition, dichroic mirror 1h generally transmits the S-polarized light whose wavelength is equal to or greater than 470 nm, while generally reflecting the S-polarized light whose wavelength is shorter than 470 nm.

In the characteristics of the incident angle of 52°, a cutoff wavelength for the P-polarized light is 435 nm, and a cutoff wavelength for the S-polarized light is 473 nm. In this case, dichroic mirror 1h generally transmits the P-polarized light whose wavelength is equal to or greater than 435 nm, while generally reflecting the P-polarized light whose wavelength is shorter than 435 nm. In addition, dichroic mirror 1h generally transmits the S-polarized light whose wavelength is equal to or greater than 473 nm, while generally reflecting the S-polarized light whose wavelength is shorter than 473 nm.

In the characteristics of the incident angle of 58°, a cutoff wavelength for the P-polarized light is 423 nm, and a cutoff wavelength for the S-polarized light is 467 nm. In this case, dichroic mirror 1h generally transmits the P-polarized light whose wavelength is equal to or greater than 423 nm, while generally reflecting the P-polarized light whose wavelength is shorter than 423 nm. In addition, dichroic mirror 1h generally transmits the S-polarized light whose wavelength is equal to or greater 467 nm, while generally reflecting the S-polarized light whose wavelength is shorter than 467 nm.

According to the spectral transmission characteristics illustrated in FIG. 6, in the wavelength region from the cutoff wavelength 435 nm of the P-polarized light in the characteristics of the incident angle of 52° to the cutoff wavelength 467 nm of the S-polarized light in the characteristics of the incident angle of 58°, the S-polarized light and the P-polarized light can be surely separated for the blue diffusion light. In other words, the wavelength region in which polarized light separation is allowed is 435 nm to 467 nm, and a difference between an upper limit and the lower limit is 32 nm. This difference is wider than 30 nm that is the difference between the upper limit and the lower limit of the range of the variation in the light emission wavelengths of the LDs. Thus, when the peak wavelength of the LD light emission spectrum is designed to be near the wavelength of the center of the wavelength region in which polarized light separation is allowed, the influence of the variation in the light emission wavelengths of the LDs can be reduced.

For example, the range of the variation in the light emission wavelengths of the LDs that is designed so that the peak wavelength of a light emission spectrum can be 450 nm is about 435 nm to 465 nm, which is within the wavelength region that allows polarized light separation. Accordingly, the influence of the variation in the light emission wavelengths of the LDs can be reduced.

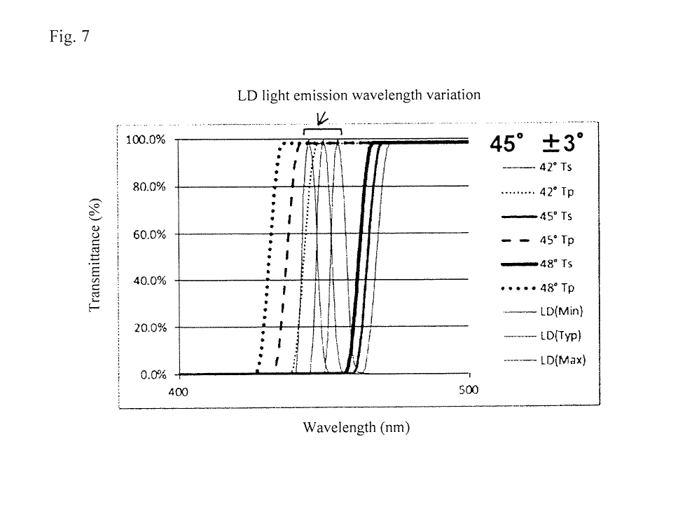

FIG. 7 illustrates the spectral transmission characteristics of a dichroic mirror when the incident angle of the central beam is 45° as a comparative example. In FIG. 7, a vertical axis indicates a transmittance, and a horizontal axis indicates a wavelength (nm). A broken line indicates characteristics for the P-polarized light, and a solid line indicates characteristics for the S-polarized light. As in the case illustrated in FIG. 6, the blue diffusion light of a diffusion angle of 3° enters the dichroic mirror. The incident angle range of the blue diffusion light is 42° to 48°. In FIG. 7, characteristics for the incident angles of 42°, 45°, and 48° are respectively illustrated.

In the characteristics of the incident angle of 45°, a cutoff wavelength for the P-polarized light is 437 nm, and a cutoff wavelength for the S-polarized light is 465 nm. In this case, the dichroic mirror generally transmits the P-polarized light whose wavelength is equal to or greater than 437 nm, while generally reflecting the P-polarized light whose wavelength is shorter than 437 nm. In addition, the dichroic mirror generally transmits the S-polarized light whose wavelength is equal to or greater than 465 nm, while generally reflecting the S-polarized light whose wavelength is shorter than 465 nm.

In the characteristics of the incident angle of 42°, a cutoff wavelength for the P-polarized light is 443 nm, and a cutoff wavelength for the S-polarized light is 468 nm. In this case, the dichroic mirror generally transmits the P-polarized light whose wavelength is equal to or greater than 443 nm, while generally reflecting the P-polarized light whose wavelength is shorter than 443 nm. In addition, the dichroic mirror generally transmits the S-polarized light whose wavelength is equal to or greater than 468 nm, while generally reflecting the S-polarized light whose wavelength is shorter than 468 nm.

In the characteristics of the incident angle of 48°, a cutoff wavelength for the P-polarized light is 431 nm, and a cutoff wavelength for the S-polarized light is 462 nm. In this case, the dichroic mirror generally transmits the P-polarized light whose wavelength is equal to or greater than 431 nm, while generally reflecting the P-polarized light whose wavelength is shorter than 431 nm. In addition, the dichroic mirror generally transmits the S-polarized light whose wavelength is equal to or greater than 462 nm, while generally reflecting the S-polarized light whose wavelength is shorter than 462 nm.

According to the spectral transmission characteristics of the comparative example illustrated in FIG. 7, in the wavelength region from the cutoff wavelength 443 nm of the P-polarized light in the characteristics of the incident angle of 42° to the cutoff wavelength 462 nm of the S-polarized light in the characteristics of the incident angle of 48°, the S-polarized light and the P-polarized light can be separated for the blue diffusion light. However, the difference between the upper limit and the lower limit of the wavelength region 443 nm to 462 nm that allows polarized light separation is 19 nm. This difference is narrower than 30 nm that is the difference between the upper limit and the lower limit of the range of the variation in the light emission wavelengths of the LDs. Therefore, it is impossible to avoid the influence of the variation in the light emission wavelengths of the LDs.

As described above, according to the embodiment, by disposing dichroic mirror 1h so that incident angle θ of the central beam of the blue light from reflection region 10B can be larger than 45°, specifically 55°, the influence of the variation in the light emission wavelengths of the LDs can be reduced.

However, the transmittance of dichroic mirror 1h decreases according to the increase of incident angle θ. For example, while the transmittance of the P-polarized light in the wavelength region allowing polarized light separation is roughly 100% in the spectral transmission characteristics illustrated in FIG. 7, the transmittance of the P-polarized light in the wavelength region that allows polarized light separation is 95% in the spectral transmission characteristics illustrated in FIG. 6. Accordingly, a part of the blue light (P-polarized light) from reflection region 10B is reflected by dichroic mirror 1h.

When the blue light (P-polarized light) reflected by dichroic mirror 1h returns to light source 1a, a LD oscillation operation becomes unstable, and as a result, the output of the LD is reduced. In particular, when there is an image forming relationship between reflection region 10B and light source 1a (light emission point of LD), the blue light from reflection region 10B returns to the light emission point of light source 1a, thus making the problem of reducing LD output more conspicuous.

According to the embodiment, in order to eliminate the blue light returning from dichroic mirror 1h to light source 1a side, polarized light separating element 1f is disposed on the optical path between dichroic mirror 1h and light source 1a. The blue light (P-polarized light) reflected by dichroic mirror 1h is transmitted through polarized light separating element 1f. The blue light (Po-polarized light) transmitted through polarized light separating element 1f travels in a direction different from the direction of light source 1a, not returning to the light emission point of light source 1a. As a result, the oscillation operation of the LD does not become unstable.

As apparent from the foregoing, according to the light source device of the embodiment, the influence of variation in the light emission wavelengths of the LDs that is caused by individual differences or temperature dependence can be reduced, and a reduction in the output of the light source that is caused by return light can be prevented.

Note that incident angle θ of the central beam of the blue light from reflection region 10B is not limited to 55°. When incident angle θ is larger than 45°, the wavelength region in which the S-polarized light and the P-polarized light can be separated can be widened, and as a result, the influence of variation in the light emission wavelengths of the LDs that is caused by individual differences or temperature dependence can be reduced.

However, when incident angle θ is larger than 45° and is shorter than 55°, a part of the wavelength region that allows the polarized light separation of dichroic mirror 1h may overlap the variability range in the light emission wavelength of the LD.

For example, when the upper limit side of the wavelength region that allows the polarized light separation overlaps the variability range in the LD light emission wavelength of the LD, depending on a LD used as light source 1a, a part of excitation light (S-polarized light) from the LD is transmitted through dichroic mirror 1h, thus causing a reduction in intensity of the excitation light radiated to phosphor unit 1l. In this case, the yellow light, the red light, the green light, and the blue light emitted from color filter unit 1n are all reduced in light intensity.

On the other hand, when the lower limit side of the wavelength region that allows the polarized light separation overlaps the variability range in the light emission wavelength of the LD, depending on a LD used as light source 1a, a part of the blue light (P-polarized light) from reflection region 10B of phosphor unit 1l is reflected to light source 1a side by dichroic mirror 1h. In this case, from among the yellow light, the red light, the green light and the blue light emitted from color filter unit 1n, the blue light is reduced in light intensity. An influence on the luminance of a projected image in this case is sufficiently smaller than that in the aforementioned case where the upper limit side of the wavelength region that allows the polarized light separation overlaps the variability range in the light emission wavelength of the LD.

Therefore, when incident angle θ is larger than 45° and less than 55°, it is desired that the upper limit wavelength of the wavelength region that allows the polarized light separation be set longer than that of the variability range in the light emission wavelength of the LD.

It is more desired that the upper limit wavelength of the wavelength region that allows the polarized light separation be set longer than that of the variability range in the light emission wavelength of the LD, and the lower limit wavelength of the wavelength region that allows the polarized light separation be set shorter than that of the variability range in the light emission wavelength of the LD. For example, since the difference between the upper limit and the lower limit of the variability range in the light emission wavelength of the LD is 30 nm, the difference between a cutoff wavelength in the spectral transmission characteristics of the S-polarized light and a cutoff wavelength in the spectral transmission characteristics of the P-polarized light is set to be at least 30 nm. Accordingly, the influence of variation in the light emission wavelengths of the LDs can be surely reduced.

The increase of incident angle θ may decrease the transmittance of the P-polarized light in the wavelength region that allows the polarized light separation of dichroic mirror 1h, thus causing a reduction in output light intensity of light source device 1. In addition, the increase of incident angle θ may increase the size and the cost of dichroic mirror 1h and enlarge the light source device.

Specifically, the blue light from light source 1a and the fluorescent light and the blue light from the phosphor wheel all enter dichroic mirror 1h as parallel light fluxes. In this case, when incident angle θ increases, the light incident region of dichroic mirror 1h widens. The wider light incident region necessitates an increase in the size of dichroic mirror 1h, thus increasing the cost of dichroic mirror 1h itself.

The larger size of dichroic mirror 1h in turn necessitates an increase in space between ¼ wavelength plate 1i and lens 1m, thus causing enlargement of light source device 1.

Further, since the angle formed between the optical axis of the blue light from the phosphor wheel and dichroic mirror 1h is smaller, the space between ¼ wavelength plate 1i and lens 1m is larger. Since the angle formed between the optical axis of the blue light from the phosphor wheel and dichroic mirror 1h becomes smaller as incident angle θ becomes larger, the space between ¼ wavelength plate 1i and lens 1m increases, thus enlarging light source device 1.

In view of the respective problems described above, it is desired that incident angle θ be set within the range of 50° to 60°.

In addition, when diffusion plate 1g of a diffusion angle of 3° is used, it is desired that incident angle θ be set to 55°. In this case, the influence of variation in the light emission wavelengths of the LDs can be surely reduced, and an increase in size and cost of dichroic mirror 1h and an increase in size and cost of the light source device can be reduced.

(Projector)

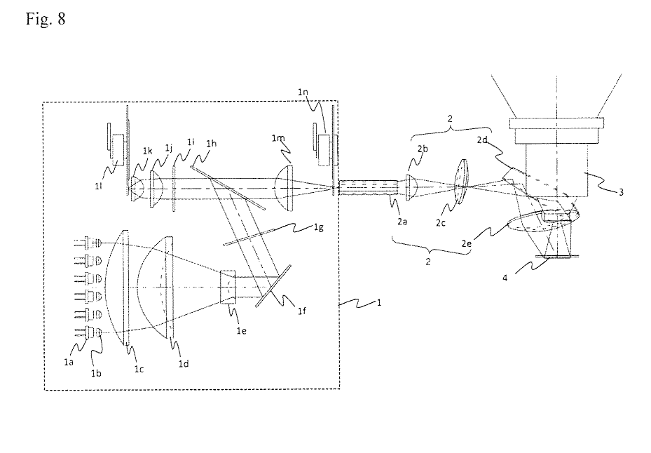

FIG. 8 illustrates the configuration of a projector including light source device 1 illustrated in FIG. 3.

Referring to FIG. 8, the projector includes light source device 1, illumination optical system 2, projection optical system 3, and display element 4.

Illumination optical system 2 guides the output light of light source device 1 to display element 4, and supplies rectangular and uniform light to display element 4. Illumination optical system 2 includes light tunnel 2a, lenses 2b, 2c, and 2e, and mirror 2d.

Light tunnel 2a has a cuboid shape, the output light of light source device 1 enters the inside from one end, and the incident light propagates through the inside to exit from the other end. The surface (incident surface) of one end of light tunnel 2a is disposed at the focal position of lens 1m of light source device 1 illustrated in FIG. 3. There is an image forming relationship between the irradiation surface of the phosphor wheel of phosphor unit 1l and the incident surface of light tunnel 2a.

The light output from the other end of light tunnel 2a is radiated to display element 4 via lenses 2b and 2c, mirror 2d, and lens 2e. Lenses 2b, 2c, and 2e are condensing lenses.

Display element 4 spatially modulates a light flux from illumination optical system 2 according to a video signal to form an image. Display element 4 is, for example, a digital micromirror device (DMD). The DMD has a plurality of micromirrors, each micromirror is configured to change an angle according to a driving voltage, and reflection angles are different between when a driving voltage indicating an ON-state is supplied and when a driving voltage indicating an OFF-state is supplied. By subjecting each micromirror to ON-OFF control according to the video signal, the incident light flux is spatially modulated to form an image. Note that a liquid crystal panel or the like can be used for display element 4 in addition to the DMD.

Projection optical system 3 magnifies and projects the image formed by display element 4 on a projection surface. Any projection surface such as a screen or a wall can be used as long as the image can be projected thereon.

### Second Exemplary Embodiment

A light source device according to the second exemplary embodiment of the present invention will be described.

The light source device according to this embodiment is configured in a manner that the relationship between the S-polarized light and the P-polarized light in light source device 1 illustrated in FIG. 3 is reversed. Specifically, the arrangement of polarized light separating element 1f, diffusion plate 1g, dichroic mirror 1h, lens 1m, and color filter unit 1n illustrated in FIG. 3 is maintained. Light source 1a, collimator lens 1b, and lenses 1c to 1e are arranged opposite to diffusion plate 1g side of polarized light separating element 1f. ¼ wavelength plate 1, lenses 1j and 1k, and phosphor unit 1l are arranged opposite to polarized light separating element 1f side of dichroic mirror 1h.

Polarized light separating element 1f has the characteristics of reflecting S-polarized light and transmitting P-polarized light. Light source 1a is disposed so that its output light can enter polarized light separating element 1f as P-polarized light.

Blue light (P-polarized light) from light source 1a enters polarized light separating element 1f via collimator lens 1b and lenses 1c to 1e. The blue light (Polarized light) is transmitted through polarized light separating element 1f to enter dichroic mirror 1h via diffusion plate 1g.

Dichroic mirror 1h has, with respect to light that is made incident as P-polarized light, the first characteristics in which light whose wavelength is equal to or shorter than a first wavelength that is longer than that of the blue light is transmitted and in which light whose wavelength is longer than the first wavelength is reflected. In addition, dichroic mirror 1h has, with respect to light that is made incident as S-polarized light, the second characteristics in which light whose wavelength is equal to or shorter than a second wavelength that is shorter than that of the blue light is transmitted and in which light whose wavelength is longer than the second wavelength. Here, the first wavelength is a cutoff wavelength in the first characteristics, and the second wavelength is a cutoff wavelength in the second characteristics. Dichroic mirror 1h having such characteristics can be realized by a dielectric multilayer film.

The blue light (P-polarized light) from polarized light separating element 1f is transmitted through dichroic mirror 1h to be radiated to phosphor unit 1l via ¼ wavelength plate 1i and lenses 1j and 1k. The blue light (P-polarized light) passes through ¼ wavelength plate 1i to be converted into circular polarized light. The blue light (circular polarized light) is sequentially radiated to yellow phosphor region 10Y, green phosphor region 10G, and reflection region 10B.

In yellow phosphor region 10Y, a yellow phosphor excited by the blue light emits yellow fluorescent light. In green phosphor region 10G, a green phosphor excited by the blue light emits green fluorescent light. In reflection region 10B, the blue light from lens 1k is reflected toward lens 1k.

The yellow fluorescent light (unpolarized light) from yellow phosphor region 10Y, the green fluorescent light (unpolarized light) from green phosphor region 10G, and the blue light (circular polarized light) from reflection region 10B respectively pass through lens 1k, lens 1j, and ¼ wavelength plate 1i sequentially to enter dichroic mirror 1h. Here, the blue light (circular polarized light) from reflection region 10B passes through ¼ wavelength plate 1i to be converted into S-polarized light. This blue light (S-polarized light) enters dichroic mirror 1h.

The yellow fluorescent light (unpolarized light), the green fluorescent light (unpolarized light), and the blue light (P-polarized light) that passed through ¼ wavelength plate 1i are reflected by dichroic mirror 1h. The yellow fluorescent light, the green fluorescent light, and the blue light reflected by dichroic mirror 1h enter the color wheel of color filter unit 1n via lens 1m.

According to the embodiment, as in the case of the first exemplary embodiment, dichroic mirror 1h is disposed so that the incident angle of the central beam of the blue light from reflection region 10B can be larger than 45°, and the blue light (S-polarized light) returning from dichroic mirror 1h to light source 1a side is eliminated by polarized light separating element 1f. Thus, the same operation effect as that of the first exemplary embodiment is provided.

In this embodiment, the modifications or the desired range of the incident angle described in the first exemplary embodiment can be applied.

In addition, the light source device of the embodiment can be applied to the projector illustrated in FIG. 8. Specifically, in the projector illustrated in FIG. 8, light source device 1 is replaced with the light source device of this embodiment.

The light source device and the projector according to the respective embodiments described above are only examples of the present invention, and the configurations and the operations thereof can be changed as occasion demands.

For example, in the first exemplary embodiment, color filter unit 1n may be omitted, a diffusion layer may be provided on reflection region 10B in the phosphor wheel of phosphor unit 1l illustrated in FIG. 4, and a part or all of yellow phosphor region 10Y may be replaced with a red phosphor region. This modification can also be applied to the second exemplary embodiment.

The present invention can employ configurations described in the following Supplementary Notes. However, the invention is limited to these configurations.

### [Supplementary Note 1]

A light source device comprising:

a light source that emits blue light having a peak wavelength in a blue wavelength region;

a polarized light separating element that is provided to reflect or transmit first linearly polarized light, the polarized light separating element reflecting or transmitting first linearly polarized light of the blue light;

a dichroic mirror that is provided to reflect or transmit the first linearly polarized light, the dichroic mirror reflecting or transmitting reflected light or transmitted light from the polarized light separating element;

a phosphor unit that includes a phosphor region in which a phosphor is provided and a reflection region in which incident light is reflected, the phosphor unit being movable so that reflected light or transmitted light from the dichroic mirror is sequentially radiated to the phosphor region and the reflection region; and

a ¼ wavelength plate that is provided on an optical path between the dichroic mirror and the phosphor unit,

wherein the dichroic mirror is disposed so that an incident angle of a central beam of the blue light that is reflected in the reflection region is larger than 45°.

### [Supplementary Note 2]

The light source device according to Supplementary Note 1, wherein the dichroic mirror has: with respect to the first linearly polarized light, a first characteristics in which light whose wavelength is equal to or longer than a first wavelength that is longer than that of the blue light is transmitted and light whose wavelength is shorter than the first wavelength is reflected; and with respect to second linearly polarized light that is orthogonal to the first linearly polarized light, a second characteristics in which light whose wavelength is equal to or longer than a second wavelength that is shorter than that of the blue light is transmitted and light whose wavelength is shorter than the second wavelength is reflected, the dichroic mirror reflecting a part of the second linearly polarized light that is made incident from the reflection region via the ¼ wavelength plate to the polarized light separating element side,

wherein the polarized light separating element has a characteristics in which the first linearly polarized light is reflect and the second linearly polarized light is transmitted, the polarized light separating element transmitting the second linearly polarized light from the dichroic mirror.

### [Supplementary Note 3]

The light source device according to Supplementary Note 2, wherein the dichroic mirror is configured so that a difference between the first wavelength and the second wavelength is greater than 30 nm.

### [Supplementary Note 4]

The light source device according to Supplementary Note 1, wherein the dichroic mirror has: with respect to the first linearly polarized light, a first characteristics in which light whose wavelength is equal to or shorter than a first wavelength that is longer than that of the blue light is transmitted and light whose a wavelength is longer than the first wavelength is reflected; and with respect to second linearly polarized light that is orthogonal to the first linearly polarized light, a second characteristics in which light whose wavelength is equal to or shorter than a second wavelength that is shorter than that of the blue light is transmitted and light whose wavelength is longer than the second wavelength is reflected, the dichroic mirror transmitting a part of the second linearly polarized light that is made incident from the reflection region via the ¼ wavelength plate to the polarized light separating element side,

wherein the polarized light separating element has a characteristics in which the first linearly polarized light is transmitted and the second linearly polarized light is reflected, the polarized light separating element reflecting the second linearly polarized light from the dichroic mirror.

### [Supplementary Note 5]

The light source device according to Supplementary Note 4, wherein the dichroic mirror is configured so that a difference between the first wavelength and the second wavelength is greater than 30 nm.

### [Supplementary Note 6]

The light source device according to any one of Supplementary Notes 1 to 5, wherein the dichroic mirror is disposed so that the incident angle of the central beam of the blue light is 50° to 60°.

### [Supplementary Note 7]

The light source device according to any one of Supplementary Notes 1 to 6, further comprising a diffusion plate that is provided on an optical path between the dichroic mirror and the polarized light separating element and that diffuses the incident light,

wherein a diffusion angle of the diffusion plate is 3°, and the dichroic mirror is disposed so that the incident angle of the central beam of the blue light is 55°.

### [Supplementary Note 8]

The light source device according to any one of Supplementary Notes 1 to 7, further comprising a color filter unit that includes a yellow transmission filter, a red transmission filter, a green transmission filter, and a diffusion region, the color filter unit being movable so that light from the phosphor unit sequentially enters the yellow transmission filter, the red transmission filter, the green transmission filter, and the diffusion region via the dichroic mirror,

wherein the phosphor region includes a yellow phosphor region in which a phosphor that emits yellow fluorescent light is provided, and a green phosphor region in which a phosphor that emits green fluorescent light is provided,

wherein the yellow fluorescent light from the yellow phosphor region sequentially enters the yellow transmission filter and the red transmission filter, the green fluorescent light from the green phosphor region enters the green transmission filter, and the blue light from the reflection region enters the diffusion region.

### [Supplementary Note 9]

A projector comprising:

the light source device according to any one of Supplementary Notes 1 to 8;

a display element that spatially modulates light output from the light source device to form an image; and

a projection optical system that magnifies and projects the image that is formed by the display element.

1. A light source device comprising:
a light source that emits blue light having a peak wavelength in a blue wavelength region;
a polarized light separating element that is provided to reflect or transmit first linearly polarized light, the polarized light separating element reflecting or transmitting first linearly polarized light of the blue light;
a dichroic mirror that is provided to reflect or transmit the first linearly polarized light, the dichroic mirror reflecting or transmitting reflected light or transmitted light from the polarized light separating element;
a phosphor unit that includes a phosphor region in which a phosphor is provided and a reflection region in which incident light is reflected, the phosphor unit being movable so that reflected light or transmitted light from the dichroic mirror is sequentially radiated to the phosphor region and the reflection region; and
a ¼ wavelength plate that is provided on an optical path between the dichroic mirror and the phosphor unit,
wherein the dichroic mirror is disposed so that an incident angle of a central beam of the blue light that is reflected in the reflection region is larger than 45°.

2. The light source device according to claim 1, wherein the dichroic mirror has: with respect to the first linearly polarized light, first characteristics in which light whose wavelength is equal to or longer than a first wavelength that is longer than that of the blue light is transmitted and in which light whose wavelength is shorter than the first wavelength is reflected; and with respect to second linearly polarized light that is orthogonal to the first linearly polarized light, second characteristics in which light whose wavelength is equal to or longer than a second wavelength that is shorter than that of the blue light is transmitted and in which light whose wavelength is shorter than the second wavelength is reflected, the dichroic mirror reflecting a part of the second linearly polarized light that is made incident from the reflection region via the ¼ wavelength plate to the polarized light separating element side,
wherein the polarized light separating element has characteristics in which the first linearly polarized light is reflected and the second linearly polarized light is transmitted, the polarized light separating element transmitting the second linearly polarized light from the dichroic mirror.

3. The light source device according to claim 2, wherein the dichroic mirror is configured so that a difference between the first wavelength and the second wavelength is greater than 30 nm.

4. The light source device according to claim 1, wherein the dichroic mirror has: with respect to the first linearly polarized light, first characteristics in which light whose wavelength is equal to or shorter than a first wavelength that is longer than that of the blue light is transmitted and in which light whose a wavelength is longer than the first wavelength is reflected; and with respect to second linearly polarized light that is orthogonal to the first linearly polarized light, second characteristics in which light whose wavelength is equal to or shorter than a second wavelength that is shorter than that of the blue light is transmitted and in which light whose wavelength is longer than the second wavelength is reflected, the dichroic mirror transmitting a part of the second linearly polarized light that is made incident from the reflection region via the ¼ wavelength plate to the polarized light separating element side,
wherein the polarized light separating element has characteristics in which the first linearly polarized light is transmitted and the second linearly polarized light is reflected, the polarized light separating element reflecting the second linearly polarized light from the dichroic mirror.

5. The light source device according to claim 4, wherein the dichroic mirror is configured so that a difference between the first wavelength and the second wavelength is greater than 30 nm.

6. The light source device according to claim 1, wherein the dichroic mirror is disposed so that the incident angle of the central beam of the blue light is 50° to 60°.

7. The light source device according to claim 1, further comprising a diffusion plate that is provided on an optical path between the dichroic mirror and the polarized light separating element and that diffuses the incident light,
wherein a diffusion angle of the diffusion plate is 3°, and the dichroic mirror is disposed so that the incident angle of the central beam of the blue light is 55°.

8. The light source device according to claim 1, further comprising a color filter unit that includes a yellow transmission filter, a red transmission filter, a green transmission filter, and a diffusion region, the color filter unit being movable so that light from the phosphor unit sequentially enters the yellow transmission filter, the red transmission filter, the green transmission filter, and the diffusion region via the dichroic mirror,
wherein the phosphor region includes a yellow phosphor region in which a phosphor that emits yellow fluorescent light is provided, and a green phosphor region in which a phosphor that emits green fluorescent light is provided,
wherein the yellow fluorescent light from the yellow phosphor region sequentially enters the yellow transmission filter and the red transmission filter, the green fluorescent light from the green phosphor region enters the green transmission filter, and the blue light from the reflection region enters the diffusion region.

9. A projector comprising:
the light source device according to claim 1;
a display element that spatially modulates light output from the light source device to form an image; and
a projection optical system that magnifies and projects the image that is formed by the display element.
